(19) United States
(12) Patent Application Publication
(10) Pub. No.: US 2026/0367705 A1
(43) Pub. Date: Nov. 19, 2026

(54) MAGNETIC ELASTOMERS FOR ELECTRONIC ACTUATORS

(71) Applicant: Apple Inc., Cupertino, CA (US)

(72) Inventor: George V Anastas, San Carlos, CA (US)

(21) Appl. No.: 19/211,139

(22) Filed: May 16, 2025

(51) Int. Cl. G06F 3/01; G06F 3/044; H01F 7/08

(52) U.S. Cl. CPC G06F 3/016; G06F 3/044; H01F 7/081

(57) ABSTRACT

Actuators for haptics and touch input devices can incorporate compressible materials having high magnetic permeability between a target member and an electromagnet. In some cases, an actuator can have magnetorheological elastomer material positioned between a pole or tine of an electromagnet of the actuator and a ferromagnetic structure or armature to improve flux transmission efficiency, thereby enabling reduced actuator size, reduce energy expenditure for equivalent force production, and/or improved manufacturing and assembly tolerances and costs.

### TECHNICAL FIELD

The present disclosure generally relates to haptic devices for touch input and specifically relates to using magnetorheological elastomers to improve efficiency and performance of haptic input devices such as trackpads.

### BACKGROUND

Electronic devices, such as portable computers, generally include trackpads for receiving user input. Trackpads can be provided in the form of integrated components that are provided in the housing of an electronic device or can be provided in the form of stand-alone components that are connected to electronic devices. For example, stand-alone keyboards that include trackpads can be connected to electronic devices such as tablet computers.

Trackpads typically include a rectangular touch surface that monitors the position of a user's finger or another external object. A user may interact with a trackpad by controlling the position of the user's fingertip on the touch surface. The trackpad may be used to control the position of a cursor on a display screen of an electronic device or to take other suitable actions. Trackpads can use multi-touch arrangements such that the movement of one or more fingers across the touch surface can be interpreted as a particular command. For example, a swipe of a user's fingertips across the touch surface can serve as a gesture that directs an electronic device to advance through a list of items. Users can also provide force-based input, often referred to as clicks, when applying a threshold amount of pressure to the trackpad, and the trackpad can provide feedback, typically haptic feedback, to indicate to the user the registry of the force-based input.

Touch input devices, such as capacitance-sensing trackpads, have evolved to enhance user interaction by integrating haptic feedback, which simulates tactile sensations without hinges, clicking domes, or other significant moving parts. These devices typically employ capacitive sensor arrays to detect gestures like taps or clicks. To mimic the feel of a physical button, advanced trackpads use electromagnets arranged near to a stationary surface. When a user applies pressure, sensors trigger the electromagnets to generate a magnetic field that interacts with a ferromagnetic structure, producing a rapid vibration or movement perceived as a “click.” This solid-state design improves durability and allows for a sleek form factor and customized feel compared to traditional mechanical trackpads. However, tight mechanical tolerances must be maintained for efficient and consistent performance of trackpads, trackpads can lack energy efficiency, and the size and positioning of actuators can limit surrounding system architecture. Furthermore, various kinds of electromechanical actuators and feedback devices need improvements to their efficiency, manufacturability, and reliability. For this and other reasons, there is a constant need for improvements in the field of electromechanical actuators, trackpads, and other touch or haptic feedback actuators.

### SUMMARY

One aspect of the present disclosure relates to a computing device, comprising: a base housing; a trackpad comprising a touch panel and a target member, the target member comprising a ferromagnetic material; an actuator coupled with the base housing and comprising an electromagnet configured to apply a magnetic force to the target member by generating a magnetic field; and a magnetorheological elastomer material disposed between the electromagnet and the target member.

In some examples, the magnetorheological elastomer material contacts the target member and contacts the electromagnet. The magnetorheological elastomer material can be spaced away from the target member by an air gap. The touch panel can be configured to move with the target member in response to the application of the magnetic force by the electromagnet. The magnetorheological elastomer can be compressible between the target member and the actuator. The actuator can comprise a variable reluctance actuator. The electromagnet can comprise a first pole and a second pole. The magnetorheological elastomer material can be positioned between the first pole and the target member and between the second pole and the target member. In some examples, the magnetorheological elastomer material includes a first portion between the first pole and the target member and a second portion between the second pole and the target member, the first portion being spaced apart from the second portion. The electromagnet can be spaced at least 0.5 millimeters away from the target member.

Another aspect of the disclosure relates to an electromechanical actuator, comprising: an armature comprising a ferromagnetic material; a conductive coil spaced away from the armature; a power source connection to electrically energize the conductive coil; and a magnetorheological elastomer positioned between the armature and the conductive coil. The conductive coil, when energized via the power source connection, can produce a magnetic field applying a force to the armature through the magnetorheological elastomer.

The conductive coil can surround a ferromagnetic tine. The magnetorheological elastomer can contact the armature and the conductive coil. The magnetorheological elastomer can comprise soft magnetic particles held by a non-magnetic substrate. The soft magnetic particles can comprise about 30 percent volume to about 40 percent volume of the magnetorheological elastomer. The magnetorheological elastomer can be compressible via movement of the armature relative to the conductive coil.

In yet another aspect of the disclosure, an electronic input device is provided, with the input device comprising: an input member including a ferromagnetic block coupled with a capacitive touch input device; a magnetorheological elastomer disposed against the ferromagnetic block; and an electromagnet disposed against the magnetorheological elastomer. In response to an electronic device sensing a user input via the capacitive touch input device, the electromagnet can generate an electric field through the magnetorheological elastomer to move the input member via the ferromagnetic block.

In some examples, in response to movement of the input member, the magnetorheological elastomer is compressed between the ferromagnetic block and the electromagnet. In response to deactivation of the electromagnet, the magnetorheological elastomer can expand between the ferromagnetic block and the electromagnet. The ferromagnetic block can include a surface having a block width, wherein the electromagnet has an electromagnet width, and the block width is substantially equal to the electromagnet width.

The above summary of the present invention is not intended to describe each embodiment or every implementation of the present invention. The Figures and the detailed description that follow more particularly exemplify one or more preferred embodiments.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is an isometric view of a computing device system.

FIG. 2 is a bottom-up view of a keyboard component of the computing device system of FIG. 1.

FIG. 3 is a bottom-up detail view of a trackpad assembly of the keyboard component of FIG. 2.

FIG. 4 is an exploded isometric view of the trackpad assembly of FIG. 3.

FIG. 5A is a top view of an actuator and attraction plate assembly of a computing device system.

FIG. 5B is a side section view of the actuator and attraction plate assembly of FIG. 5A as taken through section line 500 in FIG. 3.

FIG. 5C is an end view of the actuator of FIG. 5A.

FIG. 6 is a schematic side section view of a solenoid including a magnetorheological elastomer.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Actuators in trackpad technology have included trackpad input panels including capacitive touch sensitive arrays integrated with ferromagnetic structures that are acted upon by variable reluctance magnetic circuits/electromagnets configured to produce large forces on the trackpad input panels over small displacements. The displacements of the input panels are designed to imitate a “click” haptic response feel at the outer input surface of the input panel that is substantially equivalent to a click haptic response of a traditional/mechanical trackpad that hinges at one edge thereof to trigger a switch.

In order to ensure high energy efficiency, the electromagnets are designed to generate magnetic fields that are applied to ferromagnetic structures across short distances. The distances are minimized to maximize the forces applied to the ferromagnetic structures. The ferromagnetic structures can be spaced away from the electromagnets by an air gap so that they can move relative to the electromagnets when the magnetic fields are applied. The low magnetic permeability of air means the air gap is minimized to ensure sufficient force is generated for a sufficient click pulse to be sensed by the user. With the air gap minimized, such as at 300 microns, manufacturing and assembly tolerances of plus or minus 10-15% can significantly change the output sensation of a click pulse when an equal magnetic field acts on the ferromagnetic structure of an input panel. This change in output can reduce perceived quality, consistency of user experience, and can require costly calibration and adjustment to correct.

Magnetorheological elastomers (MREs) are a class of partially magnetic composite materials that combine fine soft-magnetic particles with an elastic, compliant, non-magnetic, elastomer binding matrix. The resulting structure is a moldable, flexible material that is magnetically permeable. This composite can be designed to be five to six times more permeable to magnetic flux than air (or more). Example MREs can include stabilized iron/carbonyl iron particles suspended and distributed through an elastomeric silicone or rubber type material. In the absence of a magnetic field, the magnetic particles are dispersed in the elastomer, and the material behaves like a typical elastically flexible rubber. When a magnetic field is applied to the MRE, the particles form chains or columns aligned with the magnetic field, thereby increasing the material's stiffness or resistance to deformation. Over short distances, the magnetic field travels through the MRE more efficiently than through air or other less magnetically permeable materials lacking the particles' ability to guide the magnetic field. The stiffness of the MRE is also less affected over small distances as compared to thicker MREs.

Actuators in a trackpad or other products that use a variable reluctance magnetic circuit architecture to produce large forces over small displacements can be more energy-efficient, effective in producing force-displacement, and space-saving by incorporating MREs in strategically important parts of the actuator, such as between a ferromagnetic target structure/attraction plate on an input plate of the trackpad and the actuator's electromagnet(s). Electromagnets, when powered, can apply a magnetic field through the MRE material to displace the input panel rather than reducing or closing an air gap. With the improved permeability of the MRE as compared to air, the input device and actuator can apply stronger forces over the same distances, or less energy (or a smaller electromagnet) is needed to apply the same forces over the same distances. In some cases, the distance between the electromagnet and the ferromagnetic target structure can be increased without reducing output forces and displacements for a given magnetic field. Thus, many benefits can be obtained by incorporating MREs into trackpad and other magnetically-activated actuators where air gaps or other spacing between parts are otherwise used.

These and other embodiments are discussed below with reference to the figures. However, those skilled in the art will readily appreciate that the detailed description given herein with respect to these figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

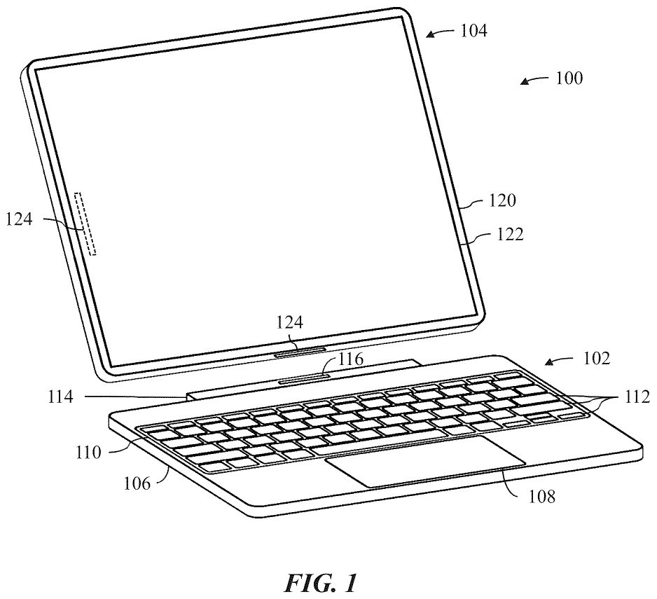

FIG. 1 shows a perspective view of a system 100 that can implement, or can be used to implement, embodiments of the present disclosure. The system 100 includes an input device 102 (also referred to as a keyboard, an external keyboard, or a computer accessory) in electrical communication with a computing system 104 (also referred to an electronic device, a tablet computer, a computer, or a computing device). The input device 102 shown in FIG. 1 and discussed throughout the present disclosure is an external keyboard (e.g., a keyboard that can be connected to and disconnected or removed from the computing system 104) that includes a trackpad. However, the keyboard of the present disclosure is merely one representative example of a device that can be used in conjunction with the systems and methods disclosed herein. The input device 102 can correspond to any form of an input device that includes a trackpad, such as a standalone trackpad, an integrated keyboard (e.g., a keyboard that is a built-in component of the computing system 104) or the like, as will be understood by a person having ordinary skill in the art. The computing system 104 shown in FIG. 1 is a tablet computer. The tablet computer of FIG. 1 is merely one representative example of a device that can be used in conjunction with the systems and methods disclosed herein. The computing system 104 can correspond to any form of an electronic device, including a cellular telephone, a smart phone, a portable media player, a media storage device, a portable digital assistant (“PDA”), a tablet computer, a computer, a laptop computer, a mobile communication device, a GPS unit, a remote control device, a smartwatch, or another electronic device.

The input device 102 can include a housing 106, a trackpad 108, a keyboard portion 110 (also referred to as a key area, a key portion, or a keyboard area) including a plurality of keys (e.g., 112), and an interface portion 114 including an electrical interface 116. The trackpad 108 and the keys 112 can be disposed in openings in a top wall or top case of the housing 106 of the input device 102. The top case of the housing 106 can be a top portion or wall of the input device 102 that defines a top surface of the input device 102, which is a surface that includes the trackpad 108 and the keys 112. The top case of the housing 106 can be opposite a bottom surface of the housing 106 on which the input device 102 is configured to sit. In examples in which the input device 102 is a built-in component of the computing system 104, the top case can refer to a top case of a keyboard portion of the computing system 104, rather than a portion of the computing system 104 that includes a display assembly. The keyboard portion 110 can be optionally omitted from the input device 102, wherein the input device 102 can define a trackpad 108 in the housing 106 without a keyboard or similar key-or button-based input device in the housing 106. The interface portion 114 can provide an electrical interface (and may also provide a physical/mechanical interface) between the input device 102 and the computing system 104. For example, the interface portion 114 can include a folding stand, a pedestal, a slot, or other components that can position and angle the computing system 104 relative to the input device 102. The interface portion 114 can include magnetic components that retain the computing system 104 in a desired position. The interface portion 114 can be adjustable between different positions, such as to retain the computing system 104 at varying angles and positions relative to the input device 102. The electrical interface 116 can include a flush-mount interface (e.g. with electrical contacts flush with a wall of the interface portion 114), spring-loaded electrical contacts (e.g., pogo pins), electrical ports, conductive jacks, conductive sockets, other suitable electrical contacts or connections, or combinations thereof. The electrical interface 116 can include magnetic components and can magnetically couple the input device 102 to the computing system 104.

The computing system 104 can include a housing 120, a display assembly 122, and one or more electrical interfaces 124. The housing 120 can be referred to as an enclosure, a case, or the like. The housing 120 can be formed from materials such as plastic, glass, ceramics, fiber composites, metals (e.g., stainless steel, aluminum, titanium, combinations or alloys thereof, or the like), other suitable materials, combinations thereof, or the like. The housing 120 can receive the display assembly 122, and the display assembly 122 can be configured to drive visual display content. The electrical interfaces 124 can provide connections between the computing system 104 and the input device 102. An electrical interface 124 can be provided on a back wall of the housing 120 (e.g., opposite the display assembly 122), along a longitudinal sidewall of the housing 120 (illustrated in FIG. 1), along a lateral sidewall of the housing 120, or the like. Any number of the electrical interfaces 124 can be included in the computing system 104. The electrical interfaces 124 can include flush-mount interfaces (e.g. with electrical contacts flush with the walls of the housing 120), spring-loaded electrical contacts (e.g., pogo pins), electrical ports, other suitable electrical contacts or connections, or the like, in a manner compatible with interfacing with the electrical interface 116 of the input device 102. The electrical interfaces 124 can include magnetic components and can magnetically couple the computing system 104 to the input device 102.

The input device 102 and the computing system 104 can be in electrical communication with one another through the electrical interface 116 of the input device 102 and the electrical interface 124 of the computing system 104. In some examples, the electrical interfaces 116, 124 can be direct electrical interfaces. For example, the electrical interfaces 116, 124 can include contacts disposed on external surfaces of the input device 102 and the computing system 104. The contacts can include a flush-mount contact on one of the input device 102 or the computing system 104 and a spring-loaded contact on the other of the input device 102 or the computing system 104. Magnetic components can be included in the electrical interfaces 116, 124 to align the electrical interfaces 116, 124 with one another and retain the electrical interfaces 116, 124 relative to one another. In some examples, the electrical interfaces 116, 124 can be indirect interfaces, and can include ports that allow for a cable to be connected between the input device 102 and the computing system 104. The electrical interfaces 116, 124 can be used to supply power from the computing system 104 to the input device 102, and to transfer data between the input device 102 and the computing system 104.

As used herein, parts in “electrical communication” with each other are configured to exchange electrical signals, directly or indirectly, between each other, whether unidirectionally or bidirectionally. An input device (e.g., the input device 102) can be said to be in electrical communication with a computing system (e.g., the computing system 104) if the computing system is using signals generated by the input device or if the computing system is using signals reliant upon or derived at least in part on the signals generated by the input device. For example, the input device 102 can be in electrical communication with the computing system 104 via electrical interfaces (e.g., the electrical interfaces 116, 124 or similar components) of the input device 102 and the computing system 104. A sensor can be said to be in electrical communication with a processor or controller device if the processor is using signals generated by the sensor, or if the processor is using signals/measurements/values reliant upon, or derived at least in part on, the signals generated by the sensor. An actuator can be said to be in electrical communication with a processor or controller device if the actuator is using signals generated by, reliant upon, or derived at least in part on signals generated by or provided from the processor.

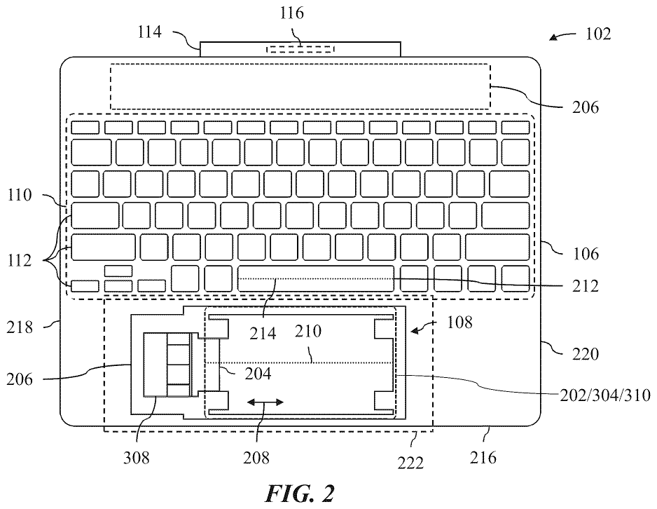

FIG. 2 illustrates a bottom view of an example implementation of the input device 102 with a back case/back wall of the housing 106 removed. FIG. 2 illustrates a layout and positioning of various components of the input device 102. As illustrated in FIG. 2, the input device 102 can include an interface portion 114, a power source 206 (e.g., capacitor bank, batteries, or an electrical utility grid connection), a keyboard portion 110 including a plurality of keys 112, and a trackpad 108. The interface portion 114 can be located at one end (e.g., a device connection end) of the input device 102, and the trackpad 108 can be opposite the interface portion 114 (e.g., at a typically user-adjacent end of the input device 102). The power source 206 can be between the interface portion 114 and the keyboard portion 110. The keyboard portion 110 can be between the power source 206 and the trackpad 108.

The trackpad 108 can include a touch assembly 202 (also referred to as a trackpad assembly or a touch stack), which includes a logic board 304 and trackpad sensors 310. The logic board 304 and the trackpad sensors 310 can have the same or similar footprints (e.g., peripheries of the logic board 304 and the trackpad sensors 310 can be the same or aligned). An attraction plate 204 (e.g., a target structure, target member, ferromagnetic block, or armature) of the trackpad 108 can be attached to the touch assembly 202. The attraction plate 204 can be rigidly fixed to the touch assembly 202. The trackpad 108 can further include a beam plate 207 and an actuator 308. The actuator 308 can be attached to the beam plate 207, and the beam plate 207 can be attached to the housing 106 of the input device 102. The actuator 308 can be rigidly fixed to the beam plate 207 and the beam plate 207 can be rigidly fixed to the housing 106. The touch assembly 202 and the attraction plate 204 can be mounted on the beam plate 207 such that relative motion between the touch assembly 202 and the beam plate 207 can be actuated by the actuator 308.

The actuator 308 can be a magnetic actuator. The actuator 308 can be actuated to apply a magnetic field to the attraction plate 204 and attract or repel the attraction plate toward or away from the actuator 308. The actuator 308 can be actuated to move, pulse, or vibrate the attraction plate 204 (and the touch assembly 202 attached to the attraction plate 204) along a movement axis 208 (e.g., in a particular direction on the movement axis 208 toward or away from the actuator 308). The movement axis 208 can be parallel to a longitudinal axis 210 of the touch assembly 202, parallel to a longitudinal axis 214 of a spacebar 212 of the keys 112, and parallel to an edge 216 of the housing 106 proximal the trackpad 108. This movement can supply haptic feedback to the touch assembly 202, wherein a user, e.g., the user's fingertip, can feel the movement of the trackpad 108 in response to the operation of the actuator 308.

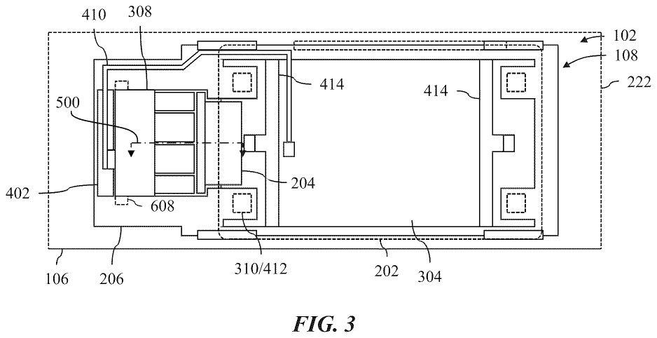

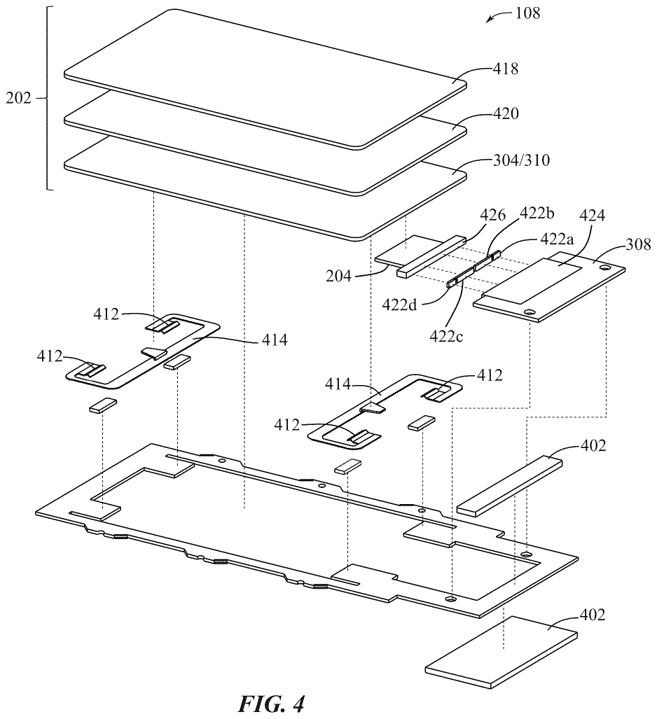

The logic board 304 (see FIGS. 3 and 4) can be connected to an electrical interface 116 of the interface portion 114 and can transfer data to and from the electrical interface 116. The logic board 304 can be connected to sensors of the keys 112 and to the trackpad sensors 310 and can supply input data to an external device (e.g., the computing system 104) based on input signals received from the sensors of the keys 112 and the trackpad sensors 310. The logic board 304 can be connected to the actuator 308 and can supply commands to the actuator 308 based on the input signals received from the trackpad sensors 310. In some examples, the logic board 304 can further supply commands to the actuator 308 based on data received through the electrical interface 116, such as from the external device/computing system 104. In some embodiments, commands to the actuator 308 can be sent to the input device 102 via a wireless interface (e.g., BLUETOOTH, Wi-Fi, or similar).

The power source 206 can be connected to the electrical interface 116 of the interface portion 114. More specifically, capacitors, batteries, or other energy storage devices of the power source 206 can be connected to the electrical interface 116 and can be charged by the electrical interface 116. The power source 206 can be connected to the actuator 308. The actuator 308 can be powered by the power source 206. The power source 206 can supply power to the actuator 308 at a rate greater than a power supply through the electrical interface 116 and can support greater actuation forces for the actuator 308 than can be supplied by the electrical interface 116. A number of energy storage devices included in the power source 206 can be determined based on actuation forces that are desired to be provided by the actuator 308. For example, a greater number of capacitors can be included in the power source 206 to provide for greater actuation forces (and greater haptic feedback forces) to be supplied by the actuator 308.

The actuator 308 can be positioned between the keyboard portion 110 and the first edge 216 of the housing 106 proximal the trackpad 108. The actuator 308 can be between the touch assembly 202 and a second edge 218 of the housing 106 adjacent to, contiguous with, and angled (e.g., perpendicular) to the first edge 216. In some examples, the trackpad 108 can be flipped such that the actuator 308 is between the touch assembly 202 and a third edge 220 of the housing 106 adjacent to, contiguous with, and angled (e.g., perpendicular) to the first edge 216 and opposite the second edge 220. Each of the first edge 216, the second edge 218, and the third edge 220 can be sidewalls of the housing 106. By positioning the actuator 308 adjacent to and outside of the touch assembly 202, the trackpad 108 can be formed with a reduced thickness. This can be used to reduce an overall thickness of the input device 102. The actuator 308 can be positioned in a palm rest area of the input device 102. For example, a user can rest their palm on the housing 106 of the input device 102 in a first palm rest area between the keyboard portion 110 and the first edge 216 and between the trackpad 108 and the second edge 218 or in a second palm rest area between the keyboard portion 110 and the first edge 216 and between the trackpad 108 and the third edge 220 when the user uses the keys 112 of the input device 102.

FIG. 3 shows a zoomed in, bottom-up view of a region 222 of FIG. 2. FIG. 3 illustrates a layout and mounting of various components of the trackpad 108 and the input device 102. For example, FIG. 3 illustrates connections to the logic board 304. The actuator 308 can be connected (e.g., electrically connected) to the logic board 304 by wires 410. The wires 410 can extend through adhesive foam layers 402, with an adhesive foam layer 402 at least partially surrounding the wires 410. The wires 410 can provide a flexible connection between the actuator 308 and the logic board 304, which allows for relative movement between the actuator 308 and the logic board 304. For example, the wires 410 can allow the logic board 304 to move relative to the actuator 308 when the actuator 308 is actuated to supply haptic feedback.

The trackpad sensors 310 can include strain gauges 412 that are between the beam plate 207 and the logic board 304. See also FIG. 4. The strain gauges 412 can detect forces between the logic board 304 and the beam plate 207, such as forces resulting from user input to the trackpad 108. The strain gauges 412 can be connected (e.g., physically and electrically connected) to the logic board 304 through connectors 414. The connectors 414 can be electrical flexes, substrates, or the like. The connectors 414 can provide a flexible connection or a rigid connection between the strain gauges 412 and the logic board 304. For example, the connectors 414 can provide a flexible connection between the strain gauges 412 and the logic board 304, which allows for relative movement between the strain gauges 412 and the logic board 304 when the actuator 308 is actuated to supply haptic feedback. In some examples, the connectors 414 can provide a rigid connection between the strain gauges 412 and the logic board 304, such that the strain gauges 412 move with the logic board 304 when the actuator 308 is actuated to supply haptic feedback. The beam plate 207 can include mounting tabs 416 (also visible in FIG. 4) onto which the strain gauges 412 are positioned.

As illustrated in FIG. 3, the actuator 308 can be disposed outside of a periphery of the touch assembly 202 in a view perpendicular to a touch surface of the touch assembly 202. The attraction plate 204 can be attached to the touch assembly 202 within the periphery of the touch assembly 202 and can extend outside of the periphery of the touch assembly 202. At least a portion of the beam plate 207 can extend under the periphery of the touch assembly 202. In some examples, the attraction plate 204 can be positioned underneath and within the periphery of the touch assembly 202, with the actuator 308 also being at least partially, and in some examples completely, underneath and within the periphery of the touch assembly 202. Thus, an electromagnet of the actuator 308 can be positioned overlapping with and within the periphery of the touch assembly 202 or can be positioned laterally adjacent to or outside the periphery of the touch assembly 202.

FIG. 4 is an exploded isometric view of the trackpad 108 including the touch assembly 202 and actuator 308. The touch assembly 202 can include a touch surface 418, an adhesive layer 420, and the logic board 304 (including trackpad sensors 310) arranged in a stack-up or layered configuration. The attraction plate 204 can be rigidly and directly mounted to the touch assembly 202, wherein the attraction plate 204 is integrated with and movable with the touch assembly 202 when acted upon by forces generated by a magnetic field of the actuator 308.

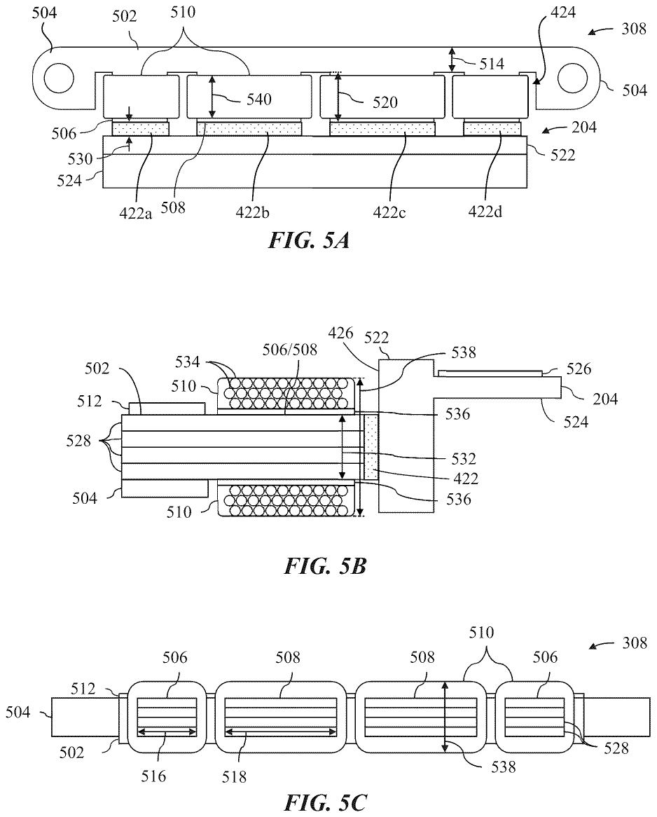

The trackpad 108 may include at least one magnetic guide member 422 positioned between the touch assembly 202 and the actuator 308. The actuator 308 can be a variable reluctance actuator. FIG. 5A shows a top view of the actuator 308, the at least one magnetic guide member 422, and the attraction plate 204. FIG. 5B shows a side cross-section of the assembly as taken through section line 500 in FIG. 3. FIG. 5C shows an end view of the actuator 308 showing surfaces that would face toward the attraction plate 204. FIGS. 5A-5C are not to scale, and other figures show the actuator 308 in a different schematic form and therefore may not match the proportions and positioning of the actuator 308 as shown in FIGS. 5A-5C.

The actuator 308 can include a back iron 502, mounting tabs 504 on either side of the back iron 502, narrow tines 506 and wide tines 508 extending from the back iron 502, and coils 510 wrapping around the tines 506, 508. In some examples, the tines 506, 508 can be poles of at least one electromagnet of the actuator 308. The actuator 308 can further include a connector 512, which can be connected to a logic board of an input device and can be used to supply electricity to the coils 510 (e.g., to electrically energize the coils 510) to actuate the actuator 308. The connector 512 can be attached to a surface of the back iron 502 by an adhesive, welding, or the like. The tines 506, 508 can act as a core of the actuator 308, and the tines 506, 508 and the coils 510 can create an electromagnet 424 to generate a magnetic field when electricity is supplied through the connector 512 to the coils 510. The back iron 502 can be formed from the material of the tines 506, 508 and can form a return path for flux between the tines 506, 508. The back iron 502 can have a depth 514 in a range from about 5 mm to about 12 mm. The mounting tabs 504 can be used to mount the actuator 308 to a beam plate of an input device and can be attached to the beam plate by welding, adhesives, screws through openings, or the like.

The narrow tines 506 can be outer tines of the actuator 308, and the wide tines 508 can be inner tines of the actuator 308. Any number of tines can be included in the actuator 308, such as, for example, three to five tines, with an outer tine on each side being a narrow tine 506 and inner tines being wide tines 508. The narrow tines 506 can have widths 516 (see FIG. 5C) in a range from about 5 mm to about 7 mm, from about 6 mm to about 7 mm, or the like. The wide tines 508 can have widths 518 in a range from about 11 mm to about 13 mm, from about 12 mm to about 13 mm, or the like. Providing the tines 506, 508 with greater widths can increase the magnetic field generated by the actuator 308 but can also increase the overall width of the actuator 308. The tines 506, 508 can have lengths 520 (see FIG. 5A) in a range from about 9 mm to about 14 mm, from about 8 mm to about 13 mm, or the like. Increasing the length 520 of the tines 506, 508 can increase the magnetic field that can be generated by the actuator 308 while also enlarging a length of the actuator 308. The attraction plate 204 can have a width (e.g., a block width) measured parallel to the widths 516, 518. The width of the attraction plate 204 can be substantially similar to the overall width of the electromagnet 424, as shown in FIG. 5A. This can help ensure that a large majority of the flux is efficiently emitted from the electromagnet 424 and passes into the attraction plate 204 to draw the attraction plate 204 toward the actuator 308.

The attraction plate 204 can include an attraction portion 522 and an attachment portion 524. The attraction plate 204 can be formed from a soft magnetic metal material, such as stainless steel or the like. In some examples, the attraction plate 204 can comprise a permanently magnetized material. The attraction portion 522 can have dimensions (e.g., a height and width) similar to overall dimensions of the tines 506, 508 and the coils 510 of the actuator 308. The attraction portion 522 can be attracted to (or repelled by, if comprising a permanently magnetized material) the magnetic field generated by the actuator 308 to move the attraction plate 204 relative to the actuator 308. The attachment portion 524 can be used to attach the attraction plate 204 to a touch assembly of an input device. The attachment portion 524 can be attached to the touch assembly by a rigid attachment mechanism, such as an adhesive 526, welding, screws, or the like.

The attraction plate 204 can be separated from the actuator 308 by a spacing distance/spacing dimension 530. See FIG. 5A. The spacing dimension 530 can have a size ranging from about 0.225 mm to about 0.375 mm, from about 0.250 mm to about 0.350 mm, or the like, and a magnetic guide member 422 can increase the strength of the magnetic forces applied to the attraction plate 204 across that distance as compared to an air gap. With a magnetic guide member 422 positioned between the actuator 308 and the attraction plate 204, the spacing dimension 530 can range from about 0.400 mm to about 0.600 mm, or can be about 0.500 millimeters, while the magnetic guide member 422 is still facilitating similar magnetic forces as when the spacing dimension 530 is about half that distance and only air separates the actuator 308 from the attraction plate 204. Reducing the size of the spacing dimension 530 between the attraction plate 204 and the actuator 308 can increase the flux and strength of the magnetic field of the actuator 308 that is applied to the attraction plate 204. Increasing the size of the spacing dimension 530 eases tolerances in manufacturing and assembly.

The tines 506, 508 and the back iron 502 of the actuator 308 can be formed from the same or different materials. As illustrated in FIGS. 5B and 5C, both the tines 506, 508 and the back iron 502, or the tines 506, 508 alone can include laminated layers 528 of materials. The tines 506, 508 and the back iron 502 of the actuator 308 can be formed from materials having a high magnetic permeability, which increases a magnetic field that can be generated by the actuator 308. In one example, the tines 506, 508 and the back iron 502 can be formed from four layers 528 of a laminated material. A number of the layers 528 included in the tines 506, 508 and the back iron 502 can be in a range from one to five layers, or from two to four layers. Forming the tines 506, 508 and the back iron 502 with fewer laminated layers 528 decreases the thickness of the actuator 308 but reduces the force that can be applied by the actuator 308 (e.g., the magnetic field produced by the actuator 308). The layers 528 of the laminated material can be separated from one another by gaps, such as a gap in a range from about 25 μm to about 30 μm, from about 26 μm to about 29 μm, or the like. The tines 506, 508 and the back iron 502 can be formed from electrical sheet steel, which can include oriented or non-oriented grains. The tines 506, 508 and the back iron 502 can be formed from silicon steel, iron cobalt alloys, or the like. The tines 506, 508 and the back iron 502 can have a thickness 532 in a range from about 0.5 mm to about 2.2 mm, from about 1.2 mm to about 2.2 mm, from about 1.2 mm to about 1.8 mm, or the like. Each of the layers 528 can have a thickness in a range from about 0.3 mm to about 0.7 mm, from about 0.35 mm to about 0.65, or the like.

Each of the tines 506, 508 can be wrapped by the coils 510. The coils 510 can include wires 534 wrapped around the tines 506, 508. The wires 534 can be wrapped around the tines 506, 508 in a number of layers, such as one to four layers (with three layers being illustrated in FIG. 5B). The wires 534 can be formed from a conductive material, such as copper, and can be coated or uncoated. The wires 534 can have diameters in a range from about 0.1 mm to about 0.2 mm, from about 0.16 mm to about 0.18 mm, from about 0.15 mm to about 0.22 mm, or the like. Each of the coils 510 can include a number of turns of the wires 534, such as from 16 to 268 turns, or from 38 to 120 turns. The coils 510 can be attached to the tines 506, 508 by adhesives 536, which can have thicknesses in a range from about 0.08 mm to about 0.12 mm. An overall thickness 538 of the actuator 308 between opposite surfaces of the coils 510 can be in a range from about 2 mm to about 3.7 mm, from about 2 mm to about 2.9 mm, from about 2 mm to about 2.6 mm, or the like. The coils 510 can have lengths 540 in a range from about 4 mm to about 13 mm, from about 9 mm to about 14 mm, from about 8 mm to about 13 mm, from about 12 mm to about 14 mm, or the like.

The at least one magnetic guide member 422 can be positioned between a laterally-facing surface 426 of the attraction plate 204 and an electromagnet portion 424 of the actuator 308. In some examples, the magnetic guide member 422 can comprise a set or plurality of magnetic guide members 422a-d (which may be collectively referred to herein by indicator 422) arranged in a pattern (e.g., a line or sequence) between the attraction plate 204 and the actuator 308. See FIGS. 4 and 5A. For instance, a set of about four magnetic guide members 422a-d can be arranged with the magnetic guide members 422a-d positioned next to each other and laterally covering different portions of the laterally-facing surface 426 or actuator 308. See FIG. 5B. In some examples, the magnetic guide members 422a-d can be spaced apart from each other and out of contact with each other. In some examples, the magnetic guide members 422 can contact, abut, or overlap each other. In some examples, a single magnetic guide member 422 can extend across and cover the entire laterally-facing surface 426, wherein the magnetic guide member 422 has an area dimension greater than or substantially equal to the surface area of the laterally-facing surface 426 that faces toward the electromagnet 424. In some examples, a single magnetic guide member 422 can extend across and cover the surface area facing the laterally-facing surface 426 on each and every tine 506, 508.

As shown in FIGS. 5A-5B, the magnetic guide members 422 can each have a depth completely filling the spacing dimension 530 between the actuator 308 and the attraction plate 204. Thus, the depths of each of the magnetic guide members 422 can be at least equal to the spacing dimension 530. In this manner, the magnetic guide members 422 can be in contact with, disposed against, and engaging both the actuator 308 and the attraction plate 204. The magnetic guide members 422 can therefore eliminate and fill any air gaps in the depth between the actuator 308 and the attraction plate 204, thereby increasing the efficiency by which magnetic flux passes from the electromagnet 424 to the attraction plate 204 since the magnetic guide members 422 have increased magnetic permeability as compared to air.

The height of the magnetic guide members 422 can be equal to the thickness 532 of the tines 506, 508, as shown in FIG. 5B. Thus, the entire end surfaces of the tines 506, 508 can be covered by the magnetic guide members 422 to enhance flux transmission efficiency of the actuator 308. In some examples, the magnetic guide members 422 can have size dimensions matching the coils 510, such as a height matching the overall thickness 538 and widths matching the widths of the coils 510. In this manner, the magnetic guide members 422 can be positioned between the conductive coils 510 and the attraction plate 204.

The magnetic guide members 422 may in some cases only contact one of the actuator 308 and the attraction plate 204. Thus, an air gap may be present between the magnetic guide members 422 and at least one of the actuator 308 and the attraction plate 204. The presence of the material of the magnetic guide members 422 between the actuator 308 and the attraction plate 204, where the magnetic field is generated, can still enhance efficiency of application of the magnetic force to the attraction plate 204.

In some examples, when the magnetic guide members 422 are laterally spaced apart from each other by lateral air gaps or spaces, the magnetic flux emitted through the tines 506, 508 can have reduced leakage and short-circuiting through other nearby magnetic guide members 422 or tines 506, 508. The spaces between the magnetic guide members 422 can each be larger in length than the depth 530 in order to help reduce or eliminate flux leakage or magnetic field short-circuiting. A single-piece magnetic guide member 422 (which would cover the surface areas of magnetic guide members 422a-d and the spaces between them) can be simpler to install, reduce part count and cost, and contribute to improved manufacturing and assembly efficiency.

The at least one magnetic guide member 422 can comprise a composite material, such as, for example, an elastomeric non-magnetic material combined with a soft magnetic material (e.g., a ferromagnetic material), a permanent magnetic material, or both (in various ratios). In some examples, a magnetorheological elastomer may be used for the at least one magnetic guide member 422. The magnetorheological elastomer may include a plurality of soft magnetic particles such as filings, particles, dust, powder, etc. that are made of a soft magnetic material such as iron or steel. For instance, the soft magnetic particles can include a stabilized iron powder. The magnetorheological elastomer may include about 20 percent to about 50 percent soft magnetic particles by volume. In some examples, the volume of soft magnetic particles can be within a range of about 10 percent to about 60 percent of the overall volume of the at least one magnetic guide member 422. In some examples, the volume of soft magnetic particles can be within a range of about 30 percent to about 40 percent of the overall volume of the at least one magnetic guide member 422. Using these volume ranges of the particles can ensure sufficient magnetic permeability of the MRE while preserving the elastic properties and compressibility of the MRE.

The soft magnetic material (and/or permanent magnetic material) can be distributed in a non-magnetic material such as an elastomeric polymer or rubber matrix. The non-magnetic material can be flexible or compressible to accommodate movement of the attraction plate 204 relative to the actuator 308. The magnetic guide members 422 can compress in response to a magnetic force being applied to the attraction plate 204 and the attraction plate 204 moving toward the actuator 308 in response. For instance, the non-magnetic material of the at least one magnetic guide member 422 can comprise an elastically compressible polymer (e.g., thermoplastic polyurethane and similar polymers) or elastically compressible rubber (e.g., silicone and similar rubbers) so that it expands and returns to its original shape after compression between the attraction plate 204 and the actuator 308. In some examples, the non-magnetic material can include an elastically compressible foam (e.g., open-cell or closed-cell) within which the soft magnetic material (and/or permanent magnetic material) is suspended or located. When permanent magnetic material is used, the material can have active magnetic properties as opposed to just passive magnetic properties. For example, an MRE material with permanent magnetic particles suspended therein can be used to magnetically preload the variable reluctance actuator, thereby permitting the actuator to drive in two directions instead of one. For example, the electromagnet can generate a first magnetic field having a first polarity configured to expand the MRE material of the at least one magnetic guide member 422, and the electromagnet can generate a second magnetic field having a different (e.g., opposite) second polarity configured to compress the MRE material of the at least one magnetic guide member 422. Thus, the attraction plate can be selectively pushed away from or attracted toward the electromagnet, dependent upon the polarity of the magnetic field generated by the electromagnet, when the at least one magnetic guide member 422 includes permanent magnetic particles.

The at least one magnetic guide member 422 can have mechanical and magnetic properties which are affected and adjusted when the at least one magnetic guide member 422 is exposed to a magnetic field from the electromagnet 424. For example, mechanical properties such as the stiffness or elasticity of the at least one magnetic guide member 422 can be adjusted (increased or decreased) based on the strength of the magnetic field emitted from the electromagnet 424. Similarly, the magnetic permeability of the at least one magnetic guide member 422 can be adjusted in response to exposure to the magnetic field of the electromagnet 424. In some examples, the magnetic permeability of at least one magnetic guide member 422 can be adjusted very quickly (e.g., substantially instantaneously) when exposed to the magnetic field. This can allow the at least one magnetic guide member 422 to have a magnetic permeability that is about five times greater than air to about six times greater than air (e.g., the at least one magnetic guide member 422 may have a relative permeability value of about 5 to about 6 when air has a relative permeability value of about 1).

Due to the positioning of the at least one magnetic guide member 422 between the attraction plate 204 and the actuator 308, the increased magnetic permeability of the at least one magnetic guide member 422 (relative to air) can increase the strength of the magnetic field that reaches the attraction plate 204 from the electromagnet 424. Accordingly, the magnetic force applied to the attraction plate 204 by the electromagnet 424 for a given magnetic field output and a given separation distance can be greatly increased when the at least one magnetic guide member 422 is positioned between them. As such, in order to generate a force on the attraction plate 204 that is similar to what would be applied when only air separates the attraction plate 204 from the electromagnet 424, the strength of the magnetic field generated by the electromagnet 424 (and the energy required to generate that field) can be significantly reduced due to the inclusion of the at least one magnetic guide member 422. Additionally or alternatively, in view of the improved force generation efficiency of the assembly, the size of the actuator 308 and attraction plate 204 can be reduced (relative to an air gap assembly) without affecting overall force applied to the touch assembly 202 when at least one magnetic guide member 422 is included. For example, fewer or smaller tines 506, 508 can be used in the electromagnet 424. Thus, the improved magnetic field transmission efficiency by the at least one magnetic guide member 422 can allow a system designer to reduce weight (e.g., due to larger parts not being required), reduce material costs of the assembly (e.g., due to larger parts not being required), increase manufacturing and assembly tolerances (e.g., due to magnetic forces being transmissible over longer gap distances).

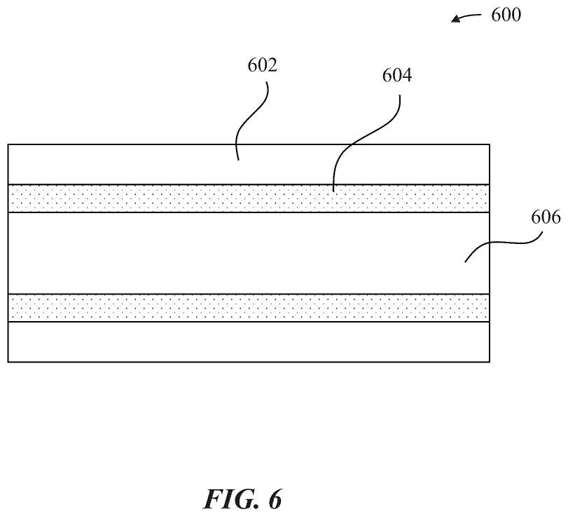

The magnetorheological elastomer materials can be used in electromechanical actuators and applications in addition to trackpads and other touch input devices. In some examples, the magnetorheological elastomer materials 604 can be applied and positioned in the space between an armature/mover 606 and a coil 602 of a solenoid 600, as shown in the schematic side section view of FIG. 6. Thus, the magnetorheological elastomer materials 604 can be positioned circumferentially around (e.g., radially outward from and surrounding) a cylindrical armature/mover 606 and radially inward from an inner cylindrical surface of a coil 602 in a solenoid assembly 600. The magnetorheological elastomer materials 604 can thereby increase the efficiency of transmission of magnetic flux from a coil 602 surrounding the armature/mover 606 of the solenoid 600, leading to increased force applied to the mover/armature or less energy needing to be expended for a force of a certain magnitude to be applied to the mover/armature. Other kinds of electromechanical actuators, particularly ones using electromagnets and electromagnetic coils to move objects, can also implement MRE material to facilitate improved efficiency and reliability of magnetic fields emitted to those objects. Thus, the present application should be understood as providing examples of certain applications of the functions and features related to the implementation of MRE materials in various actuators and devices, but those having skill in the art and the benefit of the present disclosure will understand that these features have application in many kinds of electromechanical actuators, feedback devices, haptic generators, sensors (e.g., magnetic sensors), related technologies, and combinations thereof.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

1. A computing device, comprising:
a base housing;
a trackpad comprising a touch panel and a target member, the target member comprising a ferromagnetic material;
an actuator coupled with the base housing and comprising an electromagnet configured to apply a magnetic force to the target member by generating a magnetic field; and
a magnetorheological elastomer material disposed between the electromagnet and the target member;
wherein the magnetorheological elastomer material is spaced away from the target member by an air gap.

2. The computing device of claim 1, wherein the magnetorheological elastomer material contacts the target member and contacts the electromagnet.

3. (canceled)

4. The computing device of claim 1, wherein the touch panel is configured to move with the target member in response to the application of the magnetic force by the electromagnet.

5. The computing device of claim 1, wherein the magnetorheological elastomer is compressible between the target member and the actuator.

6. The computing device of claim 1, wherein the actuator comprises a variable reluctance actuator.

7. The computing device of claim 1, wherein the electromagnet comprises a first pole and a second pole.

8. The computing device of claim 7, wherein the magnetorheological elastomer material is positioned between the first pole and the target member and between the second pole and the target member.

9. The computing device of claim 8, wherein the magnetorheological elastomer material includes a first portion between the first pole and the target member and a second portion between the second pole and the target member, the first portion being spaced apart from the second portion.

10. The computing device of claim 1, wherein the electromagnet is spaced at least 0.5 millimeters away from the target member.

11. An electromechanical actuator, comprising:
an armature comprising a ferromagnetic material;
a conductive coil spaced away from the armature;
a power source connection to electrically energize the conductive coil; and
a magnetorheological elastomer positioned between the armature and the conductive coil, the magnetorheological elastomer comprising soft magnetic particles held by a non-magnetic elastomer binding matrix;
wherein the conductive coil, when energized via the power source connection, produces a magnetic field applying a force to the armature through the magnetorheological elastomer.

12. The electromechanical actuator of claim 11, wherein the conductive coil surrounds a ferromagnetic tine.

13. The electromechanical actuator of claim 11, wherein the magnetorheological elastomer contacts the armature and the conductive coil.

14. (canceled)

15. The electromechanical actuator of claim 11, wherein the soft magnetic particles comprise about 30 percent volume to about 40 percent volume of the magnetorheological elastomer.

16. The electromechanical actuator of claim 11, wherein the magnetorheological elastomer is compressible via movement of the armature relative to the conductive coil.

17. An electronic input device, comprising:
an input member including a ferromagnetic block coupled with a capacitive touch input device;
a magnetorheological elastomer disposed against the ferromagnetic block;
an electromagnet disposed against the magnetorheological elastomer, the electromagnet including a first pole and a second pole, wherein a first portion of the magnetorheological elastomer is disposed between the first pole and the ferromagnetic block and a second portion of the magnetorheological elastomer is disposed between the second pole and the ferromagnetic block; and
wherein, in response to an electronic device sensing a user input via the capacitive touch input device, the electromagnet generates an electric field through the first portion and the second portion of the magnetorheological elastomer to move the input member via the ferromagnetic block.

18. The electronic input device of claim 17, wherein, in response to movement of the input member, the magnetorheological elastomer is compressed between the ferromagnetic block and the electromagnet.

19. The electronic input device of claim 18, wherein, in response to deactivation of the electromagnet, the magnetorheological elastomer expands between the ferromagnetic block and the electromagnet.

20. The electronic input device of claim 19, wherein the ferromagnetic block includes a surface having a block width, wherein the electromagnet has an electromagnet width, and the block width is substantially equal to the electromagnet width.
